(19) United States
(12) Patent Application Publication
(10) Pub. No.: US 2012/0291395 A1
(43) Pub. Date: Nov. 22, 2012

(54) METHOD IN THE MANUFACTURE OF AN ELEVATOR

(75) Inventor: Antti Plathin, Vantaa (FI)

(73) Assignee: KONE CORPORATION, Helsinki (FI)

(21) Appl. No.: 13/533,502

(22) Filed: Jun. 26, 2012

Related U.S. Application Data
(63) Continuation of application No. PCT/FI2010/051055, filed on Dec. 17, 2010.

(30) Foreign Application Priority Data
Dec. 31, 2009 (FI) 20090512

(51) Int. Cl. B66B 9/187; E04G 21/14

(52) U.S. Cl. 52/741.1

(57) ABSTRACT

In the method according to the invention in the manufacture of an elevator a partially completed elevator is used during the manufacture of the elevator, which elevator comprises a platform that is in the elevator hoistway during the manufacture of the elevator for supporting the elevator car via hoisting roping, and hoisting roping supported by the aforementioned platform and hanging in the elevator hoistway, in which method a lift is performed, in which the aforementioned platform is lifted to extend the operating area of the elevator car below the aforementioned platform to reach to higher in the elevator hoistway. During the lifting of the hoisting roping, the downward-pulling force exerted on the platform is reduced by transferring a part of the roping supported by the platform to be supported by a bracket that is separate from the platform for at least the duration of the lifting of the platform.

### CROSS-REFERENCE TO RELATED APPLICATIONS

This is a Continuation of PCT/FI2010/051055 filed on Dec. 17, 2010 which is an International Application claiming priority from FI 20090512 filed on Dec. 31, 2009; the entire contents of which are hereby incorporated by reference.

### FIELD OF THE INVENTION

The object of the invention is a method in the manufacture of an elevator, which elevator is preferably an elevator applicable to passenger transport and/or to freight transport and to be installed in a building. The elevator can be taken into use for passenger transport and/or for freight transport already during the construction time.

### BACKGROUND OF THE INVENTION

In connection with so-called jump-lifts, the elevator hoistway is taken into use already before the full length of the elevator hoistway has been completed. In this case the top part of the elevator hoistway is constructed at the same time as an elevator moving in the already completed lower part of the elevator hoistway serves people on the lower floors of the building. In jump-lifts the elevator car moving in the lower part of the elevator hoistway is supported and moved during construction-time use suspended on hoisting ropes that are supported by a platform in the elevator hoistway, which ropes are generally moved with a hoisting machine that is supported on the platform. When the part of the elevator hoistway under construction above the machine platform has reached a sufficient stage of completion, the completed part of the elevator hoistway can be taken into use. In this case a jump-lift is performed, wherein the machine platform is raised to a higher level in the elevator hoistway, thus extending the operating area of the elevator car upwards. A worksite crane in use in the construction of the building or a lighter hoisting device to be supported on the building and arranged for the site for the purpose of the elevator installation can, for example, be used for the lift. When the elevator hoistway has reached its final height, the machine room platform has conventionally been removed from the elevator hoistway and a machine room has been built at the end of the elevator hoistway, after which the final hoisting machine of the elevator has been brought to the machine room.

The combined weight of the machine platform and the parts of the elevator supported by it has increased owing to buildings that are taller than before. Owing to the very great travel heights of modern elevators, in particular the rope masses are so great that the combined weight to be lifted when performing the last jump-lifts is so large as to be problematic. The hoisting capacity needed for the lift is extremely large, so the hoisting arrangement has been difficult to implement cheaply, simply and space-efficiently. Even by itself, a hoisting device with its power transmission arrangements has been large and expensive to implement. Correspondingly, the support needed for the lift must also be robustly made owing to the large load. Finding a sufficiently strong supporting point, which will endure the entire mass of the machine platform and roping, has been awkward and, in turn, has complicated the hoisting arrangement.

### AIM OF THE INVENTION

The aim of the invention is to produce an improved method in the manufacture of an elevator. One aim of the invention, among others, is to eliminate the aforementioned drawbacks of prior-art solutions. The aim of the invention is further to produce one or more of the following advantages, among others:
A method is achieved in which a hoisting device of lower hoisting capacity than earlier can be used for the manufacture of an elevator.
A method is achieved in which the mass to be hoisted in a jump-lift is smaller than earlier, the advantages of which are, among others, improved safety, apparatuses can be dimensioned to be lighter, energy savings, increased freedom in the implementation of the hoisting arrangement, et cetera.
A safer method than before is achieved.
A method that uses space more efficiently than before is achieved.
A method is achieved with which a long jump-lift is easier to implement than earlier.
A method is achieved with which a construction-time elevator is easy to convert into the final elevator.

### SUMMARY OF THE INVENTION

The invention is based on the concept that in the late stage of a platform to be lifted in stepwise jump-lifts the mass to be moved in the lifting of the platform can be reduced by transferring a part of the roping supported by the platform away from being supported by the platform, more particularly to be supported by a bracket that is separate from the platform for at least the duration of the lifting of the platform. The advantages are, among others, that the hoisting arrangement required for lifting the platform can be simplified, a supporting point is easier to find, the hoisting arrangement can easily be changed to be better suited to the last lifts and can be lightened. When the masses to be moved remain smaller than earlier, also safety can be guaranteed.

In one basic embodiment of the concept according to the invention in the method in the manufacture of an elevator a partially completed elevator is used during the manufacture of the elevator, which elevator comprises a platform that is in the elevator hoistway during the manufacture of the elevator for supporting the elevator car via hoisting roping, and hoisting roping supported by the aforementioned platform and hanging in the elevator hoistway, in which method a lift is performed, in which the aforementioned platform is lifted to extend the operating area of the elevator car below the aforementioned platform to reach to higher in the elevator hoistway. During the lifting of the hoisting roping, the downward-pulling force exerted on the platform is reduced by transferring a part of the roping supported by the platform to be supported by a bracket that is separate from the platform for at least the duration of the lifting of the platform. With this the aforementioned advantages are achieved.

In a more refined embodiment of the concept according to the invention in the method in manufacturing an elevator the aforementioned part of the roping that is supported by the platform has been supported by the platform during the use of the elevator for serving passengers previous to the aforementioned lift. In this way the arrangement is made lighter at least, or only, during the lift.

In a more refined embodiment of the concept according to the invention the aforementioned bracket, to be supported by which the aforementioned part of the roping is transferred, is supported directly on the building, preferably in the proximity of the platform. Thus the bracket can take its support force from elsewhere than from the platform.

In a more refined embodiment of the concept according to the invention before the aforementioned lift an earlier lift or earlier lifts have been performed, in which lift/lifts the aforementioned part of the roping that is supported by the platform has been supported by the platform during the lift. Thus the weight to be lifted is lightened only for a later lift according to the need and unnecessary phases are avoided.

In a more refined embodiment of the concept according to the invention before the aforementioned lift an earlier lift or earlier lifts have been performed, in which lift/lifts the additional rope required by the lift was supplied to the system from the rope storage that is at the first end of the roping, and in the aforementioned lift additional rope is supplied to the system from the rope storage that is at the second end of the roping. One advantage is that the additional rope required by a later lift/later lifts can be taken from a reel comprising just a small quantity of rope, and a large reel with a mass that would disturb the elevator system is not needed.

In a more refined embodiment of the concept according to the invention before the lift the hoisting roping is fixed at its top part to a bracket that is separate from the platform such that the roping coming to the bracket from the platform travels via the bracket downwards in the elevator hoistway. Thus the bracket is arranged to support the part of the hoisting roping that continues downwards into the elevator hoistway from the bracket. In this way the downward-pulling force exerted on the platform by the part of the hoisting roping below the bracket is isolated from the platform. Thus also the mass supported by the bracket and the lightening advantage achieved can be large.

In a more refined embodiment of the concept according to the invention the hoisting roping passes around a diverting pulley of the platform that is in connection with the platform, which diverting pulley is preferably a traction sheave, and that the part of the roping that is on the first side of the diverting pulley of the platform is fixed at its top part to the aforementioned bracket, and that the roping arrangement of the part of the roping that is on the second side of the diverting pulley of the platform, which part of the roping travels from the diverting pulley of the platform to the elevator unit to be moved in the elevator hoistway, and to its fixing point that is in connection with the aforementioned elevator unit or on the building via the elevator unit or in connection with the aforementioned platform, is freed such that the part of the roping that is on the second side of the diverting pulley of the platform is able to run over the diverting pulley of the platform to the first side of the diverting pulley of the platform when raising the diverting pulley of the platform in connection with lifting the platform. Thus the rope fixing is prevented from impeding the lift. The aforementioned elevator unit is preferably an elevator car.

In a more refined embodiment of the concept according to the invention the hoisting roping passes around a diverting pulley of the platform that is in connection with the platform, which diverting pulley is preferably a traction sheave, and that the part of the roping that is on the first side of the diverting pulley of the platform is fixed at its top part to the aforementioned bracket, and that the part of the roping that is on the second side of the diverting pulley of the platform is connected to the elevator car, which is arranged to rise along with the platform in the lift L. In this case no rope needs to be freed for the lift.

In a more refined embodiment of the concept according to the invention during the lifting of the hoisting roping, the downward-pulling force exerted on the platform is reduced by transferring a part of the roping supported by the platform to be supported by at least one bracket that is separate from the platform for at least the duration of the lifting of the platform, which part of the roping forms most of the part of the roping that travels from the counterweight to the platform, more particularly to the traction sheave. In this way considerable lightening is achieved.

In a more refined embodiment of the concept according to the invention the part of the roping that is on the first side of the diverting pulley of the platform is fixed at its top part to the building, and the roping arrangement of the part of the roping that is on the second side of the diverting pulley of the platform is freed, such that the part of the roping that is on the second side of the diverting pulley of the platform is able to run over the diverting pulley of the platform to the first side of the diverting pulley of the platform when raising the diverting pulley of the platform in connection with the lifting (L) of the platform,
by opening the rope fixing to which the end of the part of the roping in question is fixed, or
by freeing the supporting of the rope loop that passes around the diverting pulley that is in connection with the aforementioned elevator unit from the elevator car, via which diverting pulley the hoisting roping travels upwards to its fixing point, or
by opening the rope fixing to which the part of the roping in question is fixed and by supplying more rope from the rope storage via the rope fixing.
   Thus the rope fixing is prevented from impeding the lift.

In a more refined embodiment of the concept according to the invention when the elevator car has a 2:1 suspension the roping is freed by detaching the end of the roping rising to the fixing from the elevator car from the fixing, in which case the rope length between the car and the fixing is freed for the purpose of the lift L. Thus the rope fixing is prevented from impeding the lift.

In a more refined embodiment of the concept according to the invention in the aforementioned lift the platform is lifted to the level of the floor of the space reserved for the final machine room of the elevator and possibly locked into its position. Thus the final lift is made to extend for a long distance and the final machine room structures can be formed from the structures of the platform.

In a more refined embodiment of the concept according to the invention before the aforementioned lift the elevator car is locked into its position in the elevator hoistway. Thus the car can be transferred away from being supported by the platform.

In a more refined embodiment of the concept according to the invention before the aforementioned lift (L) the elevator car is driven to the upper position to near the platform. Thus the length of the part of the hanging roping supported by the bracket c can be maximized and the force exerted on the platform by the part of the roping on the car side can be minimized.

In a more refined embodiment of the concept according to the invention the part of the rope of the diverting pulley of the platform, which rope is on the side of the elevator unit, which elevator unit is preferably an elevator car, continues through the bracket to a rope storage, which comprises the amount of rope required by the aforementioned lift. Thus exactly the required amount of rope can be supplied simply during the lift.

In a more refined embodiment of the concept according to the invention the aforementioned rope storage is in connection with the elevator car or the platform, and in possible preceding lifts the additional rope needed for each lift is taken from the rope storage that is at the opposite end of the roping. Thus the additional rope on the elevator car or on the platform is only for the last lifts and the extra mass to be transported along with it can be kept small. The rope storage S′ at the opposite end is preferably elsewhere, such as in the bottom part of the building.

In a more refined embodiment of the concept according to the invention the roping travels from the diverting pulley of the platform to the fixing point on the elevator car, to which fixing point the end of the roping is fastened, and that the position of the elevator car before the lift is selected such that the end of the hoisting roping on the car side does not reach to the level of the bracket c after the lift, and that before the lift L the fixing of the aforementioned end is freed such that the aforementioned end is able to rise in the elevator hoistway. Thus a rope storage is not necessarily needed at all. After this the rope length must be matched or it can be changed for the final roping.

In a more refined embodiment of the concept according to the invention before the aforementioned lift an earlier lift or earlier lifts have been performed, in which earlier lift the aforementioned platform is lifted to extend the operating area of the elevator car below the platform to reach to higher in the elevator hoistway. Thus the lift L can form a late lift in the process.

In a more refined embodiment of the concept according to the invention during the time between the aforementioned lift and the previous lift the elevator car has served passengers.

In a more refined embodiment of the concept according to the invention in the aforementioned lift the platform is lifted with a hoist supported on a structure of the space reserved for the final machine room. Thus the platform can be lifted to the level of the floor of the machine room.

In a more refined embodiment of the concept according to the invention between the lifting of the platform and the previous lifting of the platform the hoisting arrangement of the platform is converted into one possessing a lower hoisting capacity, preferably in one or some of the following ways:
by reducing the number of hoisting devices,
by reducing the lifting ratio,
by using a weaker hoisting device for the lift.
   Thus the hoisting arrangement and/or support point can be simplified and the lift can be performed to high enough.

In a more refined embodiment of the concept according to the invention in the aforementioned lift the platform is lifted with a hoist and in the lifting of the platform preceding the aforementioned lift the platform is lifted with a different hoist. Thus the most suitable hoist for the need can be selected after the load situation has changed.

In a more refined embodiment of the concept according to the invention in the aforementioned lift the platform is lifted with a hoist supported on a structure of the space reserved for the machine room and in the lifting of the platform preceding the aforementioned lift the platform is lifted with a hoist supported on the elevator hoistway, which hoist is preferably supported on opposite wall structures of the elevator hoistway with a support structure 6 that reaches across the elevator hoistway. Thus an efficient and reliable method is achieved.

In a more refined embodiment of the concept according to the invention, before the aforementioned lift
the structures of the platform are disassembled, and/or
the hoisting arrangement used for the previous lift is disassembled and/or
the hoisting device used for the previous lift is removed and/or
the support structure used for the previous lift is removed.

Thus the hoisting arrangement for the lift L can be simplified and/or the weight to be lifted can be further lightened.

In a more refined embodiment of the concept according to the invention, the parts of the platform, more particularly its support structure, are used for forming the structure that supports the machine of the final machine room of the elevator, which platform has earlier been in its position in a position disposed lower in the elevator hoistway, and which platform was used in the aforementioned lower disposed position for supporting the machine. Thus an ecological method that is efficient in materials is achieved, in which method there are few intermediate phases.

In a more refined embodiment of the concept according to the invention, after the previous lift the platform is supported in its position in the elevator hoistway supported by the support structure of the platform, which support structure extends to rest on the top surface of a load-bearing structure of the building on at least two opposite sides of the elevator hoistway. Thus the support structure of the machine can be left in use.

In a more refined embodiment of the concept according to the invention, in the lift L the support structure is lifted through from the aperture of the space that is an extension of the elevator hoistway and is reserved for the final machine room, after which the support structure is lowered to rest on the load-bearing structures of the building, preferably to rest on the top surfaces comprised in the load-bearing structures. Thus an efficient and safe method is achieved.

In a more refined embodiment of the concept according to the invention, the platform comprises a support structure, which can be moved between a contracted and an extended position, and that the platform is lifted to the level of the floor of the space reserved for the final machine room by lifting the support structure through from the aperture leading into the space that is an extension of the elevator hoistway, such that the support structure is in the contracted position, after which the support structure is moved into the extended position, in which position the support structure extends to over the load-bearing structures, and the support structure is lowered to rest on the aforementioned load-bearing structures. Thus an efficient and safe method is achieved, which method could be utilized already earlier.

In a more refined embodiment of the concept according to the invention, in the extended position the support structure extends to over a load-bearing structure on at least two opposite sides of the aperture. Thus an efficient and safe method is achieved, which method could be utilized already earlier in the method.

Based on the concept of the invention that in the lifting of a platform to be lifted in stepwise jump-lifts the mass to be moved can be reduced by transferring the part of the roping supported by the platform away from being supported by the platform, in the late stage of the process containing consecutive lifts the part of the roping hanging from the elevator car can be transferred away from being supported by the platform. Thus the lift/lifts of a late stage can be extended to higher than has earlier been possible. This is preferably implemented in the second basic embodiment of the concept according to the invention such that in the method in the manufacture of an elevator a partially completed elevator is used during the manufacture of the elevator, which elevator comprises a platform that is in the elevator hoistway during the manufacture of the elevator for supporting the elevator car, and the part of the roping hanging supported by the elevator car, which roping is preferably the roping that connects the counterweight and the elevator car and is arranged to travel from the elevator car to the diverting pulley that is in the bottom part of the hoistway, passing below it, and to travel onwards to the counterweight, and in which method one or more previous lifts are performed, in each of which lift/lifts the aforementioned platform is lifted to extend the operating area of the elevator car below the aforementioned platform to reach to higher in the elevator hoistway, in which previous lift/lifts the elevator car is during the lift supported by the platform. After at least one previous lift mentioned in the method a lift is performed in the method, in which lift the aforementioned platform is lifted to extend the operating area of the elevator car below the aforementioned platform to reach to higher in the elevator hoistway, and the downward-pulling force exerted on the platform is reduced by locking the elevator car into its position in the elevator hoistway before the aforementioned lift. In this way it is possible to transfer the elevator car and the part of the roping hanging supported by the elevator car away from being supported by the platform at least for the duration of the lift in a phase where one or more previous lifts have already been performed, which previous lift is such that after it the elevator car is again taken into use. Thus the downward-pulling force exerted on the platform by the elevator car and by the roping hanging supported by it during the lift can be reduced in order to increase the maximum lifting reach. Also the other aforementioned advantages can thus be achieved.

In a more refined embodiment of the concept according to the invention before the lift the elevator car is driven to the upper position to near the platform, after which the elevator car is locked into its position in the elevator hoistway at least for the duration of the lift.

In a more refined embodiment of the concept according to the invention the elevator car is locked into its position in the elevator hoistway by locking it to the guide rails of the elevator car or to the brackets of the guide rails of the elevator car or to the wall structures of the elevator hoistway.

In a more refined embodiment of the concept according to the invention before the aforementioned lift an earlier lift or earlier lifts is/are performed, in which lift/lifts the additional rope required by the lift was supplied to the system from the rope storage that is at the first end of the hoisting roping of the elevator, and in the aforementioned lift additional rope is supplied to the system from the rope storage that is at the second end of the hoisting roping.

In a more refined embodiment of the concept according to the invention in the aforementioned lift the platform is lifted to the level of the floor of the space reserved for the final machine room of the elevator.

In a more refined embodiment of the concept according to the invention the aforementioned rope storage is in connection with the elevator car, and the additional rope needed for each lift in possible preceding lifts is taken from the rope storage that is at the opposite end of the roping.

In a more refined embodiment of the concept according to the invention in the aforementioned lift the platform is lifted with a hoist supported on a structure of the space reserved for the final machine room.

In a more refined embodiment of the concept according to the invention in the aforementioned one or more previous lifts the elevator car is lifted along with the aforementioned platform. Thus the rope lengths match well.

In a more refined embodiment of the concept according to the invention the aforementioned roping that is hanging supported by the elevator car connects the counterweight and the elevator car and is arranged to travel from the elevator car to the diverting pulley that is in the bottom part of the hoistway, passing below it, and to travel onwards to the counterweight.

Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features/procedures of the various embodiments of the invention can be applied within the framework of the basic inventive concept in conjunction with any other embodiment or embodiments whatsoever. The additional features mentioned by each embodiment might also singly and separately from the other embodiments form a separate invention.

### LIST OF FIGURES

In the following, the invention will be described in detail by the aid of some examples of its embodiments with reference to the attached drawings, wherein

FIGS. 1a-1e diagrammatically present phase by phase a preferred embodiment of the method according to the invention.

FIG. 2 presents an arrangement, which is advantageous to utilize in the phase presented by FIG. 1a.

FIG. 3 presents an arrangement, which is advantageous to utilize in the phase presented by FIG. 1d.

### DETAILED DESCRIPTION OF THE INVENTION

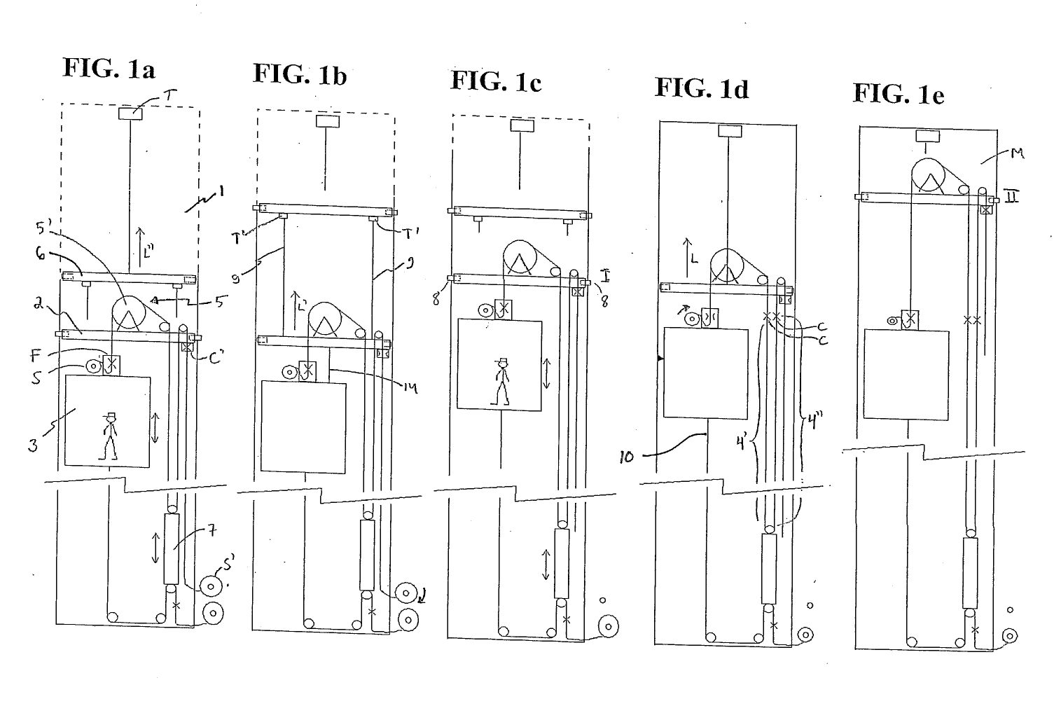

FIG. 1a presents an arrangement in a phase of the method, in which phase a partially completed elevator is used during the manufacture of the elevator, before the elevator hoistway 1 is completed throughout its full length. The elevator car 3 serves passengers in the already completed bottom part of the elevator hoistway 1 at the same time as the top part of the elevator hoistway is being built. The elevator comprises a platform 2 in the elevator hoistway 1 for supporting the elevator car 3 via hoisting roping 4 below the platform 2, and hoisting roping 4 supported by the aforementioned platform 2 and hanging in the elevator hoistway 1, which hoisting roping is moved for moving the elevator car with a hoisting machine 5 that is on the platform 2.

The situation of FIG. 1a has been arrived at e.g. with a previous jump-lift. In this phase the next lift is prepared, in which for the purpose of lifting the platform 2 the movable support structure 6 that is to be supported on the wall structures of the elevator hoistway 1 and is arranged above the platform 2 is lifted to such a height that the platform 4 supported by it can be lifted a suitable distance. The support structure can be moved to higher with a hoist T supported in the elevator hoistway. The platform 2 is suspended via hoisting means (rope 9, hoist T′) supported by the structure 6. Still before the lift L′ the elevator car is removed from driving and is driven to its upper position and suspended from the platform 4 supported by a fixing rope or a chain 14. Finally, the bracket c′, to which the part of the hoisting roping 4 that is in use travels, and via which bracket the hoisting roping 4 continues to the rope storage S′, is opened.

In the phase of FIG. 1b a lift L′ is performed in which lift the platform 2 is lifted to extend the operating area of the elevator car 3 below the platform 2 to reach to higher in the elevator hoistway 1 with the hoisting means (rope 9, hoist T′) arranged to act between the structure 6 and the platform 4, which hoisting means are arranged to lift the supporting platform 4 while it is being supported by the structure 6 upwards in the elevator hoistway 1. The vertical support force needed for lifting is taken from the building by means of the structure 6 that is supported on the wall structures of the elevator hoistway. During the lift L′ the amount of hoisting rope required by the lifting of the platform 2 is released from the rope storage S′. After the lift L′ the suspension 14 is removed and the fixing c′ is fixed. The rope lengths are adjusted, if necessary, and the elevator car is taken into use for serving passengers in the manner presented in FIG. 1c.

FIG. 1d presents a phase of the method in which a lift L is performed, in which lift the platform 2 is lifted upwards in the elevator hoistway 1. After the previous lift L′ and before the lift L the part of the roping 4 supported by the platform 2 is transferred according to the invention to be supported by a bracket c that is separate from the platform 2 for at least the duration of the lifting of the platform 2 for reducing the downward-pulling force exerted on the platform 2 during the lifting of the hoisting roping 4. The aforementioned part (4′, 4″) of the roping 4, which is transferred to be supported by the bracket c, has been supported by the platform 2 during the use of the elevator for serving passengers following the lift L′ preceding the lift L, and forms most of the part of the roping that travels from the counterweight 7 to the platform 2.

The hoisting roping 4 is thus before the lift fixed at its top part to (at least one) bracket c that is separate from the platform such that the roping 4 coming to the bracket from the platform travels via the bracket c downwards in the elevator hoistway 1. The bracket c, to be supported by which the aforementioned part (4′,4″) of the roping 4 is transferred before the lift L, is supported directly on a rigid structure of the building (preferably in the proximity of the platform 2) such that the bracket does not rise while being supported by the platform 2 during the lift. Thus the bracket c is arranged to support the part of the hoisting roping that continues downwards into the elevator hoistway from the bracket. In this way the downward-pulling force exerted on the platform by the part (4′, 4″) of the hoisting roping 4 below the bracket c is isolated from the platform 2.

The hoisting roping 4 passes around a diverting pulley (5) of the platform that is in connection with the platform, which diverting pulley is in the embodiment presented a traction sheave. The part of the roping that is on the first side of the traction sheave (5) is fixed at its top part to the aforementioned bracket c, and the part of the roping that is on the second side of the diverting pulley of the platform, which part of the roping travels from the diverting pulley of the platform to the elevator unit (preferably an elevator car) to be moved in the elevator hoistway, and to its fixing point F that is in connection with the elevator car. The roping arrangement is freed for the purpose of the lift L such that the part of the roping that is on the second side of the diverting pulley 5′ of the platform 2 is able to run over the diverting pulley 5′ of the platform to the first side of the diverting pulley of the platform when raising the diverting pulley 5′ in connection with the lifting L of the platform 2. This freeing is performed in the embodiment presented by opening the fixing F of the part of the roping that is on the second side of the diverting pulley, via which fixing the roping 4 travels to the rope storage S that is in connection with the elevator car, from where during the lift L additional rope is supplied via the fixing F. The freeing could also be performed in some other manner.

The part of the rope of the diverting pulley 5′, which in the embodiment presented is the traction sheave of the hoisting machine 5 supported by the platform, that is on the elevator car side continues through the fixing F to the rope storage S, which contains the amount of rope required by the aforementioned lift L, which rope is essentially the amount of the length of the lift when the elevator car has a 1:1 lifting ratio. In the lift L′ performed before the lift L all the additional rope required by the lift is supplied to the system from the rope storage S′, which is at the first end of the roping, and in the lift L additional rope is supplied to the system from the rope storage S, which is at the second (opposite) end of the roping. One advantage is that the additional rope required by the later lift L can be taken from a reel comprising just a small quantity of rope, and the size of the rope storage has not hampered the moving of the elevator car.

In the method preferably before the lift L the elevator car 3 is driven to the upper position to near the platform 2. Thus the part of the roping of the diverting pulley 5′ of the platform that is on the elevator car side exerts little downward-pulling force on the platform 2. During the lift L the elevator car 3 is locked into its position in the elevator hoistway 1. Thus the downward-pulling force exerted on the platform 2 can be reduced, more particularly by transferring in this way the elevator car 3 and the part of the roping 10 hanging supported by the elevator car 3 away from being supported by the platform 2. The elevator car 3 is preferably locked into its position in the elevator hoistway 1 by locking it to the guide rails of the elevator car 3 or to the brackets of the guide rails of the elevator car 3 or to the wall structures of the elevator hoistway 1. The locking is marked in FIG. 1d with a triangle.

After the lift L the bracket c is opened, c′ is closed and the elevator car 3 is again taken into use for serving passengers. Later, more corresponding lifts can be performed if the achieved height of the platform 2 is not the final height. After the lift L the hoisting roping can again be taken into use for moving the elevator car 3, or the hoisting roping can be replaced with new hoisting roping if it is desired to finish the elevator in this way into its final configuration.

In the method preferably between the lift L and the previous lift L′ the hoisting arrangement of the platform 2 is converted into one possessing a lower hoisting capacity. Thus the hoisting arrangement for the lift L can be changed to become more advantageous. This is particularly advantageous if the lift is the final lift because the final lift might require special arrangements when the end of the elevator hoistway is so near that finding support is awkward and/or the dimensions (particularly the vertical dimensions) of the platform make the lift awkward. The hoisting arrangement is converted into one possessing a lower hoisting capacity, preferably in one or some of the following ways,
by reducing the number of hoisting devices,
by reducing the lifting ratio,
by using a weaker/smaller hoisting device for the lift,

This can be done as presented such that the hoisting arrangement of the platform 2 between the lift L and the previous lift L′ is converted as presented in the figures such that in the lift the platform is lifted with a hoist T and in the lifting L′ of the platform 2 preceding the aforementioned lift the platform 2 is lifted with a different hoist T′. The hoist T can be a hoist that has earlier moved the installation platform in the top parts of the elevator hoistway. In the lift L the platform is preferably lifted with a hoist supported in the machine room. Thus it is simple to pull the platform 2 with the hoist T to the level of the floor of the final machine room, at which level it can be locked. Thus the parts of the platform 2, more particularly its support structure 18, can be used for forming the structure supporting the machine 5 of the final machine room of the elevator. In the lifting L′ of the platform 2 preceding the lift the platform 2 is lifted with a hoist T′ supported on the elevator hoistway, which hoist is preferably supported on opposite wall structures of the elevator hoistway with a support structure 6 that reaches across the elevator hoistway. Before the lift L the support structure 6 and the hoisting means (T′,9) can be removed. Before the lift L parts can also be removed from being in connection with the platform 4 supporting the machine so that the vertical dimensions of the platform do not hamper it fitting to be disposed at the desired height at the level of the floor of the final machine room.

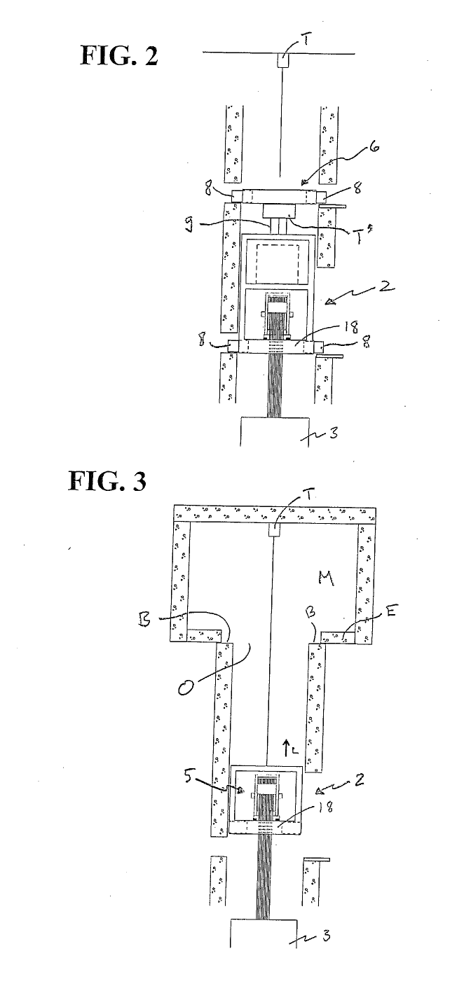

FIG. 2 partially presents a preferred implementation of the situation according to FIG. 1a and an apparatus/arrangement that is advantageous to utilize in the lift L′. The structure 6 is supported on the wall structures of the elevator hoistway 1 for taking the vertical support force needed for lifting the platform 2 from the building, more particularly from its load-bearing concrete frame parts. In FIG. 2 the platform 2 is in its position in the elevator hoistway 1 in a so-called lower disposed position I, and the platform 2 is used for supporting the machine 5 and the machine 5 is used for moving the elevator car.

FIG. 3 partially presents a preferred implementation of the situation according to FIG. 1d in performing the lift L. The arrangement presented by FIG. 2 is converted into that presented by FIG. 3 for the purpose of the lift L when the platform 2 is raised with a lift/with lifts L′ to the upper parts of the elevator hoistway. This is particularly advantageous if it is the last lift and the purpose is to raise the platform 2 to high in the elevator hoistway, more particularly to the level of the floor of the space reserved for the final machine room. As preparatory procedures for the lift L, some parts are removed from being in connection with the platform 2, more particularly
the hoisting means (9,T′), which are arranged to lift the supporting platform (4) while it is being supported by the support structure (6) upwards in the elevator hoistway (1) in connection with jump-lifts, preferably at least the hoisting device (9),
a part of the structure of the platform that supports the machine, preferably at least those parts of the frame of the platform that supports the machine that are above the machine, preferably such that the total height of the platform that supports the machine essentially decreases,
the support structure 6 above the machine, supported on which support structure the platform that supports the machine is moved upwards in the elevator hoistway in connection with jump-lifts,

These parts can be removed from being in connection with the platform 4 e.g. via the landing apertures. In this case the structure of the platform becomes lighter and smaller for the next phases of the method. At least the support structure 18, to which the machine 5 is fixed, is left and not disassembled from the platform. The removal of the parts is not however necessary. For the purpose of the lift L, the platform 2, which thus in this phase comprises at least a support structure 18, is suspended from a hoisting device T that is higher than the platform. In the last lift L presented in FIG. 3, the support structure 18 is lifted vertically to the higher position II through from the aperture O of the space M that is an extension of the elevator hoistway 1 and is reserved for the final machine room, after which the support structure 18 is lowered to rest on load-bearing structures of the building, preferably to rest on the top surfaces B comprised in the load-bearing structures. Thus the parts of the platform 2, more particularly its support structure 18, can be used for forming the structure supporting the machine 5 of the final machine room of the elevator, supported on which support structure 18 the platform 2 was, after the previous lift L′, supported in its position in the elevator hoistway 1. The support structure 18 comprised in the platform 2 extends to rest on the top surface of a load-bearing structure of the building on at least two opposite sides of the elevator hoistway 1 for supporting on the elevator hoistway, so that it can easily be utilized later as it is. For the purpose of supporting, the platform, more particularly its support structure 18, can be moved between a contracted and an extended position. The support structure is lifted to the level of the floor of the space M reserved for the final machine room by lifting the support structure 18 through from the aperture O leading into the space M that is an extension of the elevator hoistway 1 such that the support structure is in the contracted position, after which the support structure is moved into the extended position, in which position the support structure 18 extends to over the load-bearing structures, and the support structure is lowered to rest on the aforementioned load-bearing structures. In the extended position the support structure 18 extends to over a load-bearing structure on at least two opposite sides of the aperture O.

The lifting of the platform is advantageous to perform with a hoisting device T, which takes the vertical support force needed for lifting from a structure of the space M reserved for the machine room, preferably such that the support force can be taken from higher than the level of the top surface of the floor of the space M reserved for the machine room. This structure is in the figures a roof structure of the space M, but other preferred alternatives are the walls and/or an additional support structure arranged in the space M, which additional support structure is preferably supported on the floor E. In this way a sufficiently reliable lifting point that will bear the load to be moved can be guaranteed. Likewise, in this way with the arrangement the structure 18 can be lifted sufficiently high. By means of the aforementioned additional support structure the point of support can be raised to above the floor level of the machine room.

After each lift (L′,L) the platform 2 can be supported in its position in the elevator hoistway supported by the support structure 18 of the platform that supports the machine 5, which support structure extends to rest on the top surface of a load-bearing structure of the building on at least two opposite sides of the elevator hoistway. For this purpose the platform 2, more particularly its support structure 18, comprises support means 8, by the aid of which the support structure 18 can be moved between a contracted and an extended position. For this purpose also a wall of the elevator hoistway can comprise pockets that open towards the elevator hoistway, or alternatively load-bearing beams.

FIG. 1c shows that during a lift L′ rope is released from the rope storage S′ such that the tail of the rope rises upwards in the hoistway along with the lifting of the platform. This reduces the mass that is supported by the platform but it is not necessary; instead the rope could also be so long that even after the lift L′ it continues to the storage S′, which would facilitate e.g. replacing the roping later by pulling with the old rope. The arrangement is changed between the phases of FIGS. 1c and 1d by removing parts from it and/or by changing the hoist. It is obvious that this is not necessary, but instead the lift L could in some cases be advantageous to perform also without changing the hoisting arrangement essentially or at all in this phase. If it is desired to transfer the part of the roping 4 below the bracket c′ away from being supported by the platform, it can be done e.g. by detaching the diverting pulley from being supported by the platform during the lift. The diverting pulley can be supported on the building close to the platform during the lift or it can be lifted higher already before the lift. For the purpose of the lifting L of the roping, the part of the roping on the car side does not necessarily need to be freed because the car can be arranged to rise along with the platform as in phase 1b.

The roping 4 does not necessarily need to lead via the fixing F to the rope storage, but instead the end of the roping could be fixed to a fixing F on the car and freeing could in this case be performed by detaching the end of the rope and by allowing it to rise along with the lift separately from the elevator car. In this case the position of the elevator car before the lift is selected such that the end of the hoisting roping on the car side does not after the lift reach to the level of the bracket (c), and before the lift the fixing of the aforementioned end is freed such that the aforementioned end is able to rise in the elevator hoistway. One way to implement freeing when the elevator car has a 2:1 suspension would be to detach the end of the rope rising to the fixing from the elevator car from the fixing, in which case the rope length between the car and the fixing would be freed for the purpose of the lift L. In this case the end of the roping can be lowered to the car before the lift. Another way to implement the freeing when the elevator car has a 2:1 suspension would be to free the supporting of the rope loop that passes around the diverting pulley that is in connection with the aforementioned elevator unit from the elevator car, to which diverting pulley the roping descends from the platform (e.g. from the traction sheave) and via which diverting pulley the hoisting roping travels upwards to its fixing point. FIG. 1d shows that the roping 4 is fixed at two of its points, but the simultaneous use of both is not necessary because the presence of one fixing already produces the aforementioned advantages. The rope storage S could also be on the platform 4, in a solution wherein the elevator car has a 1:2 suspension, in which case the rope would travel from the traction sheave 5 via the diverting pulley that is on the elevator car upwards back to the platform and to the rope storage S. The bracket c can be a prior-art bracket, which does not let the rope run via the bracket, at least not downwards. The elevator hoistway 1 is preferably formed inside the building, which is preferably a tower building, and is vertical and can comprise e.g. concrete walls. The guide rails (not shown) of the elevator car in the part of the elevator hoistway 1 below the supporting platform 4 are already fixed to the walls of the elevator hoistway. With the method, the elevator under construction will come to form the final elevator of the building for serving passengers after the building is completed.

It is obvious to the person skilled in the art that the invention is not limited to the embodiments described above, in which the invention is described using examples, but that many adaptations and different embodiments of the invention are possible within the frameworks of the inventive concept defined by the claims presented below. For example, during the lifting of the platform 2 the downward-pulling force exerted on the platform 2 by the roping 4 and/or 10 could also be reduced already in previous lifts. It is also obvious that a moving force could in fact be produced in the hoisting roping in some other manner. For example, the hoisting machine/traction sheave could be elsewhere than what is presented, e.g. on the base of the hoistway. It is obvious that although the procedures of the embodiments according to the concept of the invention are described together, they could also be applied separately to each other.

1. Method in the manufacture of an elevator, in which method a partially completed elevator is used during the manufacture of the elevator, which elevator comprises during the manufacture of the elevator
a platform in the elevator hoistway for supporting the elevator car via the hoisting roping, and
hoisting roping supported by the aforementioned platform and hanging in the elevator hoistway,
in which method a lift is performed, in which the aforementioned platform is lifted to extend the operating area of the elevator car below the aforementioned platform to reach to higher in the elevator hoistway, wherein during the lifting of the hoisting roping, the downward-pulling force exerted on the platform is reduced by transferring a part of the hoisting roping supported by the platform to be supported by a bracket that is separate from the platform for at least the duration of the lifting of the platform.

2. Method according to claim 1, wherein the aforementioned part of the roping that is supported by the platform has been supported by the platform during the use of the elevator for serving passengers previous to the aforementioned lift.

3. Method according to claim 1, wherein the aforementioned bracket, to be supported by which the aforementioned part of the roping is transferred, is supported directly on the building, preferably in the proximity of the platform.

4. Method according to claim 1, wherein before the aforementioned lift an earlier lift or earlier lifts have been performed, in which lift/lifts the aforementioned part of the roping that is supported by the platform has been supported by the platform during the lift.

5. Method according to claim 1, wherein before the aforementioned lift an earlier lift or earlier lifts have been performed, in which lift/lifts the additional rope required by the lift was supplied to the system from the rope storage that is at the first end of the roping, and in the aforementioned lift additional rope is supplied to the system from the rope storage that is at the second end of the roping.

6. Method according to claim 1, wherein before the lift the hoisting roping is fixed at its top part to a bracket that is separate from the platform such that the roping coming to the bracket from the platform travels via the bracket downwards in the elevator hoistway.

7. Method according to claim 1, wherein the hoisting roping passes around a diverting pulley of the platform that is in connection with the platform, which diverting pulley is preferably a traction sheave, and in that the part of the roping that is on the first side of the diverting pulley of the platform is fixed at its top part to the aforementioned bracket, and in that the roping arrangement of the part of the roping that is on the second side of the diverting pulley of the platform, which part of the roping travels from the diverting pulley of the platform to the elevator unit to be moved in the elevator hoistway, and to its fixing point that is in connection with the aforementioned elevator unit or on the building via the elevator unit or in connection with the aforementioned platform, is freed such that the part of the roping that is on the second side of the diverting pulley of the platform is able to run over the diverting pulley of the platform to the first side of the diverting pulley of the platform when raising the diverting pulley of the platform in connection with the lifting of the platform.

8. Method according to claim 1, wherein during the lifting of the hoisting roping, the downward-pulling force exerted on the platform is reduced by transferring a part of the roping supported by the platform to be supported by at least one bracket that is separate from the platform for at least the duration of the lifting of the platform, which part of the roping forms most of the part of the roping that travels from the counterweight to the platform, more particularly to the traction sheave.

9. Method according to claim 1, wherein the part of the roping that is on the first side of the diverting pulley of the platform is fixed at its top part to the building, and in that the roping arrangement of the part of the roping that is on the second side of the diverting pulley of the platform is freed, such that the part of the roping that is on the second side of the diverting pulley of the platform is able to run over the diverting pulley of the platform to the first side of the diverting pulley of the platform when raising the diverting pulley of the platform in connection with the lifting of the platform,
by opening the rope fixing to which the end of the roping is fixed, or
by freeing the supporting of the rope loop that passes around the diverting pulley that is in connection with the aforementioned elevator unit from the elevator car, via which diverting pulley the hoisting roping travels upwards to its fixing point, or
by opening the rope fixing and by supplying more rope from the rope storage via the rope fixing.

10. Method according to claim 1, wherein in the aforementioned lift the platform is lifted to the level of the floor of the space reserved for the final machine room of the elevator.

11. Method according to claim 1, wherein the part of the rope of the diverting pulley of the platform, which part of the rope is on the side of the elevator unit, which is preferably an elevator car, continues through the fixing to a rope storage, which comprises the amount of rope required by the aforementioned lift.

12. Method according to claim 1, wherein the aforementioned rope storage is in connection with the elevator car, and in possible preceding lifts the additional rope needed for each lift is taken from the rope storage that is at the opposite end of the roping.

13. Method according to claim 1, wherein in the aforementioned lift the platform is lifted with a hoist supported on a structure of the space reserved for the final machine room.

14. Method according to claim 1, wherein between the aforementioned lifting of the platform and the previous lifting of the platform the hoisting arrangement of the platform is converted into one possessing a lower hoisting capacity, preferably in one or some of the following ways,
by reducing the number of hoisting devices,
by reducing the lifting ratio,
by using a weaker hoisting device for the lift.

15. Method according to claim 1, wherein before the aforementioned lift
the structures of the platform are disassembled, and/or
the hoisting arrangement used for the previous lift is disassembled, and/or
the hoisting device used for the previous lift is removed and/or
the support structure used for the previous lift is removed.

16. Method according to claim 1, wherein the parts of the platform, more particularly its support structure, are used for forming the structure supporting the machine of the final machine room of the elevator, which platform has earlier been in its position in a position disposed lower in the elevator hoistway, and which platform was used in the aforementioned lower disposed position for supporting the machine.

17. Method according to claim 1, wherein the support structure is lifted through from the aperture of the space that is an extension of the elevator hoistway and is reserved for the final machine room, after which the support structure is lowered to rest on the load-bearing structures of the building, preferably to rest on the top surfaces comprised in the load-bearing structures.

18. Method in the manufacture of an elevator, in which method a partially completed elevator is used during the manufacture of the elevator, which elevator comprises during the manufacture of the elevator
a platform in the elevator hoistway for supporting the elevator car, and
roping hanging supported by the elevator car,
in which method one or more previous lifts are performed, in each of which lift/lifts the aforementioned platform is lifted to extend the operating area of the elevator car below the aforementioned platform to reach to higher in the elevator hoistway, in which earlier lift/lifts the elevator car is during the lift supported by the platform, wherein after the at least one aforementioned lift, in the method a lift is performed, in which the aforementioned platform is lifted to extend the operating area of the elevator car below the aforementioned platform to reach to higher in the elevator hoistway, and in that the downward-pulling force exerted on the platform is reduced by locking the elevator car into its position in the elevator hoistway before the aforementioned lift, more particularly by transferring in this way the elevator car and the part of the roping hanging supported by the elevator car away from being supported by the platform.

19. Method according to claim 18, wherein before the aforementioned lift the elevator car is driven to the upper position to near the platform, after which at least for the duration of the lift the elevator car is locked into its position in the elevator hoistway.

20. Method according to claim 18, wherein the elevator car is locked into its position in the elevator hoistway by locking it to the guide rails of the elevator car or to the brackets of the guide rails of the elevator car or to the wall structures of the elevator hoistway.

21. Method according to claim 18, wherein in the aforementioned at least one previous lift, the additional rope required by the lift is supplied to the system from the rope storage that is at the first end of the hoisting roping comprised in the elevator, and in the aforementioned lift additional rope is supplied to the system from the rope storage that is at the second end of the hoisting roping.

22. Method according to claim 18, wherein in the aforementioned lift the platform is lifted to the level of the floor of the space reserved for the final machine room of the elevator.

23. Method according to claim 18, wherein the aforementioned rope storage is in connection with the elevator car, and in possible preceding lifts the additional rope needed for each lift is taken from the rope storage that is at the opposite end of the roping.

24. Method according to claim 18, wherein in the aforementioned lift the platform is lifted with a hoist supported on a structure of the space reserved for the final machine room.
